(19) United States
(12) Patent Application Publication
(10) Pub. No.: US 2006/0146929 A1
(43) Pub. Date: Jul. 6, 2006

(54) Method and system for acceleration of lossy video encoding owing to adaptive discarding poor-informative macroblocks

(75) Inventors: Anatoli Tikhotski, St. Petersburg (RU); Sergei Gramnitski, St. Petersburg (RU); Victor Redkov, St. Petersburg (RU); Aleksandr Maiboroda, St. Petersburg (RU); Mikhail Sall, St. Petersburg (RU)

Correspondence Address: JONATHAN V. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/031,370

(22) Filed: Jan. 6, 2005

(51) Int. Cl. H04N 11/04; H04B 1/66; H04N 7/12; H04N 11/02

(52) U.S. Cl. 375/240.03; 375/240.24; 375/240.18; 375/240.12; 375/240.2

(57) ABSTRACT

Disclosed herein is a method for acceleration of video encoding owing to adaptive discarding macroblocks is based on objective regularities between numerical characteristics used on successive stages of lossy encoding process. This method enables to avoid a large amount of computation and transformation being not necessary due to the fact that their results would be reduced to zero on stage of quantization. The early revelation of these regularities and adaptive control of discarding technique produce a very effective encoding scheme that can be used in the encoding systems that are aimed to extremely fast processing of video streams, in particular, in multi-channel codecs.

### BACKGROUND OF THE INVENTION

1. Field of the Invention

The present invention relates generally to digital video compression, and more particularly, to a high-performance algorithm that has particular utility in extremely fast digital video encoders.

Many different video compression algorithms have been developed for digitally encoding (“compressing”) video data in order to minimize the bandwidth required to transmit the digitally-encoded video data (“digital video data”) for a given picture quality. Several multimedia specification committees have established and proposed standards for encoding audio and video data. The most widely known and accepted international standards have been proposed by the Moving Pictures Expert Group (MPEG), including the MPEG-1, MPEG-2, MPEG-4 and by the Telecommunication Standardization Sector of the International Telecommunication Union (ITU-T), including the H.261, H.263 standards.

All these compression algorithms use a combination of encoding frames of the given video sequence as I-pictures and P-pictures. An I-picture is coded using only the information contained in that picture, and hence, is referred to as an “Intra-coded” or “Intra” picture. A P-picture is coded using motion compensated prediction (or “motion estimation”) based upon information from a past reference (or “anchor”) picture, and hence, is referred to as a “Predictive” or “Predicted” picture. Here it is intended one type of prediction, namely, the temporal prediction.

In short, these encoding algorithms use motion estimation to code those parts of sequential pictures that vary due to motion, where possible. More particularly, the current picture is divided into set of “macroblocks”. As a rule, each macroblock relates to 16 pixels by 16 lines of luminance component and the spatially corresponding 8 pixels by 8 lines of chrominance component of the color image. Further, a macroblock consists of four luminance blocks and the two spatially corresponding color difference blocks. Each luminance or chrominance block thus relates to 8 pixels by 8 lines. For the current macroblock, a “motion vector” (MV) is searched. The motion vector specifies the location of the macroblock within the current picture relative to its original location within the anchor picture, based upon a comparison between the pixels of the current macroblock and corresponding array of pixels in the anchor picture within a given search range.

Once the motion vector for a particular macroblock has been determined, the pixel values of the closest-matching macroblock in the anchor picture identified by the motion vector are subtracted from the corresponding pixels of the current macroblock, and the resulting differential values are then encoded. Such kind of coding is referred to as an “Inter-coding”.

Both Intra-coding and Inter-coding are based on some kind of transforms. The Discrete Cosine Transform (DCT) and the Wavelet Transform (WT) are the most often used techniques in video compression area. For performing DCT, every macroblock is generally divided into blocks. After the current macroblock is transformed, the obtained coefficients of this transformation are quantized. The set of quantized coefficients together with the motion vector, mode flags, and quantization parameters are the subjects for lossless entropy encoder. Because quantized coefficients have not uniform distribution and there are very many quantized coefficients that are equal to zero, the entropy encoding is very effective. Moreover, for additional compression if all the quantized coefficients of the current block are equal to zero, the special flag is input into bitstream instead of the set of quantized coefficients. The ordered set of the flags for every block forms a code pattern of the current macroblock.

Generally speaking, there exists an inherent trade-off between the speed of encoder, on the one hand, and the accuracy of the encoded digital video data (and thus, the resultant picture quality), on the other hand. The overarching goal is to devise such encoding strategy that optimizes quality and performance while minimizing the required compute effort and compute time.

2. Discussion of the Related Art

A typical transform-based block-oriented encoder is shown in generalized form in FIG. 1. The main elements of the encoder are a predictor P 80 based on motion estimation and motion compensation, a subtractor 10 of the input and predicted signals, a direct block transformer T 30, an inverse block transformer T⁻¹ 60, a quantizer Q 40, a dequantizer Q⁻¹ 50, an adder 70, a coding control unit CC 90, and a coding mode switch S1 (S1-1 20 and S1-2 21).

In Intra-coding mode, the flag ‘p’ for INTRA/INTER is set to state INTRA; the switch S1 is set to position 1 (both its sections S1-1 20 and S1-2 21 are switched to their positions 1), and the input signal is passed to the direct block transformer T 30 omitting the subtractor 10. The obtained coefficients of this transformation are quantized by the quantizer Q 40. The set of quantized coefficients Cq is passed to a lossless entropy encoder, and farther, these codes are put by a multiplexer into the bitstream. The flag value ‘p’ and the quantizing parameter value are also put by a multiplexer into the bitstream. At the same time, the set of quantized coefficients Cq is passed to dequantizer Q⁻¹ 50 and farther, to the inverse block transformer T⁻¹ 60 in order to reconstruct original frame. This reconstruction is similar to decoding process and it is carried out in order to obtain the anchor picture that will be used for prediction of a next frame. No addition is required for the reconstruction of Intra frame (switch section S1-2 21 is switched to position 1) because during its encoding there was no subtraction (switch section S1-1 20 is also switched to position 1).

In Inter-coding mode, the flag for INTRA/INTER is set to state INTER; the switch S1 is set to position 2 (both S1-1 20 and S1-2 21 sections), and the input signal is passed to the direct block transformer T 30 via the subtractor 10 where the difference of the current macroblock and predicted one is calculated. So, the subject of transformation T in the transformer 30 and quantization Q in the quantizer 40 is the difference block (or macroblock) but not full-range pixel set. Therefore, a large part of quantized coefficients Cq are equal to zero. If all the quantized coefficients of the current macroblock are equal to zero, the special flag ‘t’ is put into bitstream instead of the set of quantized coefficients.

The mode flag ‘p’, the quantizing parameter ‘q’, and the motion vector ‘MV’ used for motion compensation of the current macroblock are coded and put into bitstream, as well. Then, the set of quantized coefficients Cq is passed to the dequantizer Q⁻¹ 50 and farther, to the inverse block transformer T⁻¹ 60 in order to reconstruct the difference macroblock. The reconstructed difference macroblock is added to the predicted one passed by the switch section S1-2 21. The reconstructed macroblock is a part of the frame used for prediction of a next frame, etc.

This is a typical way of encoding process in generalized form. In addition to above mentioned INTRA and NTER mode, there are entire set of derived modes, for example, B-mode based on bidirectional prediction and so on. In case of specific targets, the implementation of the encoding process has certain features. In particular, there have to be entire complex of peculiarities in the encoding systems that are aimed to extremely fast processing of video streams. The general structure of such encoder has to contain no superfluous passing, transformation, reorganization, conversion, and copying data. All transforms are performed “on the spot” if it is possible. All computations are replaced mostly by table functions. A combined specific data structure is used for joint quantizing/quantizing operations. Special streaming and parallel executions are used for acceleration of the encoding process without decrement of quality and compression. If this optimization does not reach required performance, one can exploit a trade-off between the speed of encoder, on the one hand, and the accuracy of the encoded digital video data, on the other hand. In such a way, the function for evaluation of macroblocks matching, the Mean Squared Error (MSE) is replaced with another one, the Sum of Absolute Differences (SAD) that is computational simpler. The thorough search method of motion estimation is replaced with some rough one being faster. The searching process is forced to be aborted as soon as the criterion function retrieves satisfactory fit but not optimal one. All such approaches are directed to speed up the encoding process even if the results will insignificant worse.

If these approaches to parameter optimization of above mentioned encoding structure still does not reach required frame rate, the reason appears to optimize the structure. Disclosed herein is a method for significant acceleration of encoding by means of early revelation of poor-informative macroblocks and adaptive discarding them out the encoding process.

### SUMMARY OF THE INVENTION

The present invention is directed to a method and system for acceleration of lossy video encoding. The invented method and system are based on objective regularities between numerical characteristics used on successive stages of lossy encoding process. The optimal application of these regularities makes possible adaptive discarding poor-informative macroblocks that substantially obviates one or more problems due to limitations and disadvantages of the related art and provide for reaching certain aim such as the maximization of calculation speed under the minimal quality loss or the optimal quality under minimal time expenditure, etc.

Additional features and advantages of the invention will be set forth in the description which follows, and in part will become apparent from the description, or may be learned by practice of the invention. The features and advantages of the invention may be realized and attained by the structure particularly pointed out in the written description and claims hereof as well as the appended drawings.

To achieve these and other advantages and in accordance with the purpose of the invention, as embodied and broadly described herein, there is provided a method for acceleration of transform-based block-oriented video encoding, the method comprising besides the main encoding steps of:
a) frame predicting based on motion estimation and motion compensation,
b) subtracting the input and predicted signals,
c) direct block transforming the difference signal,
d) quantizing the coefficients of the transform,
e) dequantizing the quantized coefficients,
f) inverse block transforming of the dequantized coefficients,
g) adding the inverse transformed signal and the predicted signal, and
h) storing the reconstructed signal obtained in the step g) for frame predicting of the next video frame in the step a),
   the additional steps for acceleration of the predictive encoding as follows:
i) comparing the residual error of motion estimation with two threshold values: the assigned value T1 and the boundary value T2 that is greater than T1 value by a predefined small supplement,
j) switching out of the all encoding steps from b) to g) for the blocks having the residual error of motion estimation not greater than assigned T1 value and passing the predicted signals from the step a) directly to the step h),
k) switching on the collection of statistics for the blocks having the residual error of motion estimation in the interval between the assigned value T1 and the boundary value T2,
l) adapting the assigned value T1 on the base of collected statistics of macroblock significance criterion,
m) defining the boundary value T2 in accordance with assigned value T1 adapted in step 1).

In a further aspect of the present invention, there is provided a system for acceleration of transform-based block-oriented video encoder, the system comprising besides the main encoding units of:
a frame predictor based on motion estimation and motion compensation,
a subtractor the input and predicted signals,
a direct block transformer of the difference signal,
a quantizer of the coefficients of the transform,
a dequantizer of the quantized coefficients,
an inverse block transformer of the dequantized coefficients,
an adder of the inverse transformed signal and the predicted signal
a memory for the reconstructed signal obtained in the adder for usage by the frame predictor for the next video frame,
a coding controller, and
a switch for changeover of coding modes,
   the additional units for acceleration of the predictive encoding as follows:
a first comparator of the residual error of motion estimation with the assigned threshold value T1,
a second comparator of the residual error of motion estimation with the boundary value T2 that is greater than the assigned threshold value T1 value by a predefined small supplement,
a first switch for disconnection of the encoding units: the subtractor, the direct block transformer, the quantizer, the dequantizer, the inverse block transformer, and the adder, for the blocks having the residual error of motion estimation not greater than assigned T1 value and passing the predicted signals from the frame predictor directly to the memory for the reconstructed signal,
a second switch for engaging the collection of statistics for the blocks having the residual error of motion estimation greater than the assigned value T1 and less than the boundary value T2,
an adaptive discarder for adapting the assigned value T1 and the boundary value T2 on the base of collected statistics.
   It is to be understood that both the foregoing general description and the following detailed description of the present invention are exemplary and explanatory and are intended to provide further explanation of the invention as claimed.

### BRIEF DESCRITION OF THE DRAWINGS

The accompanying drawings, which are included to provide a further understanding of the invention and are incorporated in and constitute a part of this specification, illustrate embodiment(s) of the invention and together with the description serve to explain the principle of the invention. In the drawings:

FIG. 1 illustrates the general structure of a related art video encoder.

FIG. 2 shows a diagram of Mean Number of non-zero quantized Coefficients (MNC) of macroblocks versus residual Sum of Absolute Difference (SAD) calculated during the motion estimation of these macroblocks.

FIG. 3 shows the family of experimental curves “MNC versus residual SAD” obtained for different values qᵢ of quantizing parameter q under testing video sequence ‘Paris.cif’ from ISO/MPEG test suite.

FIG. 4A illustrates the adaptive method for control of the discarding rule when the real calculated MNC_{I} value is less than the fixed MNC_{T} value. In this case, increment of the assigned SAD_{T} value is desired for the next frame compared to previous one.

FIG. 4B illustrates the adaptive method for control of the discarding rule when the real calculated MNC_{II} value is greater than the fixed MNC_{T} value. In this case, decrement of the assigned SAD_{T} value is necessary for the next frame.

FIG. 5 shows the general structure of the video encoder according to the invented method.

### DETAILED DESCRIPTION OF THE INVENTION

Reference will now be made in detail to embodiments of the present invention, examples of which are illustrated in the accompanying drawings. Wherever possible, the same reference numbers will be used throughout the drawings to refer to the same or like parts.

The object of the invention is to provide a powerful method for significant acceleration of video encoding for the encoding systems that are aimed to extremely fast processing of video streams, in particular, in multi-channel codecs. This acceleration is reached by means of early revelation of poor-informative macroblocks and adaptive discarding them out the encoding process. The early revelation of poor-informative macroblocks is based on objective regularities between numerical characteristics used on successive stages of lossy encoding process. One of the main problems for solving the task is the choice of an optimal criterion of macroblock information significance. At that the main factor is the aim of the adaptive discarding method. There are different aims which can be reached using special criteria:

The maximization of calculation speed under the minimal quality loss;

The optimization of encoding quality;

The optimal quality under minimal time expenditure.

The general scheme of the algorithm keeps invariable irrespective of criteria. Further the first variant is considered as preferred embodiment. At that the Mean Number of non-zero quantized Coefficients (MNC) of macroblocks is selected as criterion.

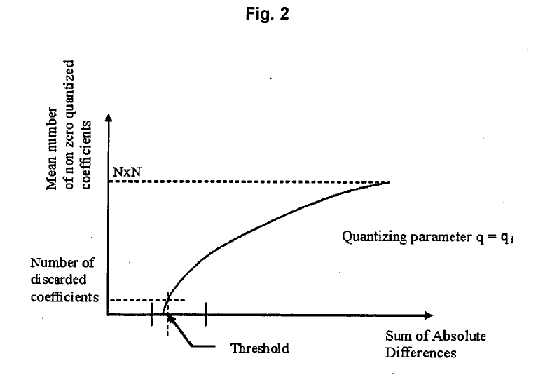

FIG. 2 shows a diagram of Mean Number of non-zero quantized Coefficients (MNC) of macroblocks versus residual Sum of Absolute Difference (SAD) calculated during the motion estimation of these macroblocks. It is seen from this diagram if the SAD of a macroblock does not exceed a value SADₒ, than the macroblock will contain on average only zero coefficients after transform T and quantization Q. Such macroblocks are not to be neither encoded nor reconstructed by inverse transform T⁻¹ and dequantization Q⁻¹. Under absolute precise encoding, this decision can be made only after transform T and quantization Q completed. But for purpose of the acceleration of the encoding process, the rational behavior is to avoid wholly these operations beginning from motion compensation up to inserting reconstructed macroblock into the frame stored for the next prediction. Moreover, for purpose of the forced acceleration, the expedient action is to discard off all such macroblocks whose residual SAD calculated during the motion estimation does not exceed a predefined threshold value. This macroblocks discarding causes throwing away some number of quantized coefficients, but it strongly speeds up whole encoding process.

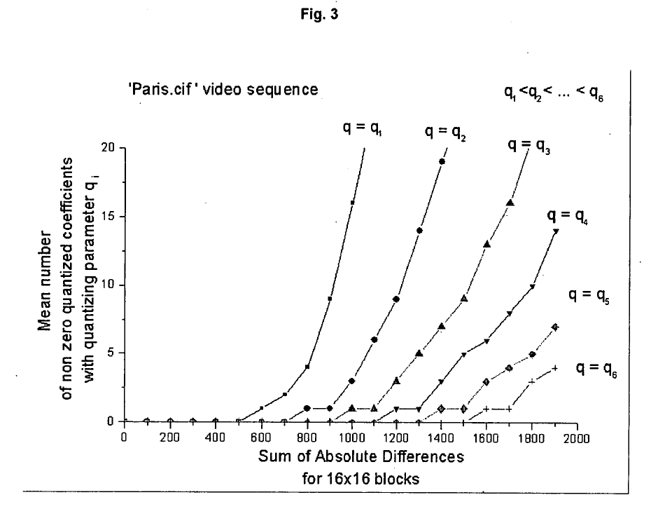

FIG. 3 shows the family of experimental curves “MNC versus residual SAD” obtained for different values qi of quantizing parameter q under testing video sequence ‘Paris.cif’ from ISO/MPEG test suite. One can see that the SADₒ value and the slope of every curve depend on the assigned quantizing parameter value. So, for effective macroblock discarding, it is possible to set certain threshold value SAD_{T} for every quantizing parameter value q: SAD_{T}=F(q). This regularity can be implemented as a pre-calculated table function. In order to make the discarding rule to be independent on all working conditions including the current content of video sequence, the invented method is adaptive and it is based on feedback correction of the threshold value SAD_{T} according with statistical result of previous frame encoding.

According to the invention, the method for adaptive macroblocks discarding processes every current macroblock distinguishing three cases as follows. Lets a certain MNC_{T} value is fixed and appropriate value of SAD_{T} is assigned from the pre-calculated table function SAD_{T}=F(q) according with assigned quantizing parameter value q. The motion estimation procedure retrieves a residual SAD value for the current macroblock. There are three distinguishing cases:

1) SAD≦SAD_{T};

2) SAD_{T}<SAD≦SAD_{T}+Δ, where Δ is a small vicinity of the SAD_{T} value;

3) SAD_{T}+Δ<SAD.

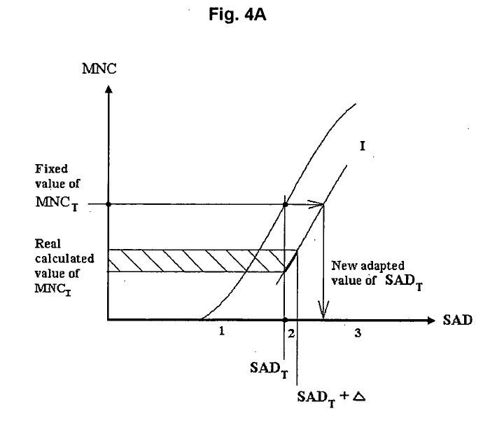

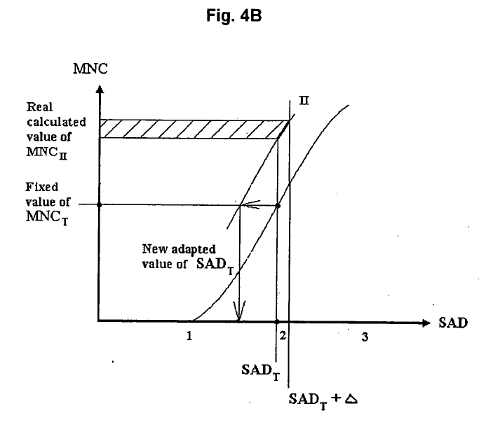

The case (1) signifies that this macroblock is poor-informative and can be discarded without any processing. The case (3) signifies that this macroblock is significantly informative and its processing is necessary. The boundary case (2) has two meanings: this macroblock is processed similar to the case (3) but in addition, statistics is calculated for this processing. Namely, the real number of non-zero quantized coefficients is calculated, gathered, and averaged for further adaptation of the discarding rule. When all macroblocks of the current frame are processed, the mean value of real counted numbers of non-zero quantized coefficients, MNC is calculated for those macroblocks that are satisfied to the conditions of case (2). At that, there can be three following situations. In the situation ‘I’ illustrated in FIG. 4A, the MNC_{I} value is less than the fixed MNC_{T} value. Therefore, the assigned SAD_{T} value shall be increased for the next frame compared to previous one. In the situation ‘II’ (see FIG. 4B), the MNC_{II} value is greater than the fixed MNC_{T} value. Therefore, the assigned SAD_{T} value shall be decreased for the next frame. The third situation MNC_{III}=MNC_{T} is a special case of the both above described ones and increment/decrement is to be equal 0. So, the direction of increment/decrement for the SAD_{T} adaptation depends on the sign of the difference (MNC_{T}−MNC) while the quantity of this increment/decrement is inversely proportional to the slope of the curve MNC versus SAD. Generally, the new value of assigned SAD_{T} can be formalized as follows:
SAD_{T}(k+1)=SAD_{T}(k)+(MNC_{T}−MNC(k))/L,
where L is the slope of the curve MNC versus SAD,

k=0, 1, . . . is the frame number of video sequence.

SAD_{T}(0) is assigned from the pre-calculated table function SAD_{T}=F(q) according with chosen quantizing parameter value q and fixed value of MNC_{T}.

This adaptive method for control of the discarding rule makes dependence on initial settings and content change to be evanescent.

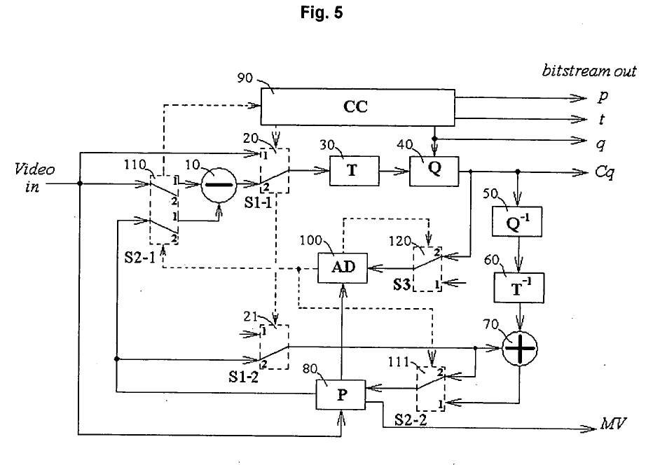

In accordance with the invented method, described below operations are performed with the current frame picture divided into a set of macroblocks. A general block-scheme of the preferred embodiment of the invented method is shown in FIG. 5 including a Subtractor 10, a First Two-Section Switch unit which switches the Section 20 and the Section 21 in coordination, a Direct Transformer (T) 30, a Quantizer (Q) 40, a Dequantizer (Q⁻¹) 50, an Inverse Transformer (T⁻¹) 60, an Adder 70, a Predictor (P, Picture Memory With Motion Compensation unit) 80, a Coding Control unit (CC) 90, an Adaptive Discarder (AD) 100, a Second Two-Section Switch unit which switches the Section 110 and the Section 111 in coordination, and a Single-Section Switch unit 120.

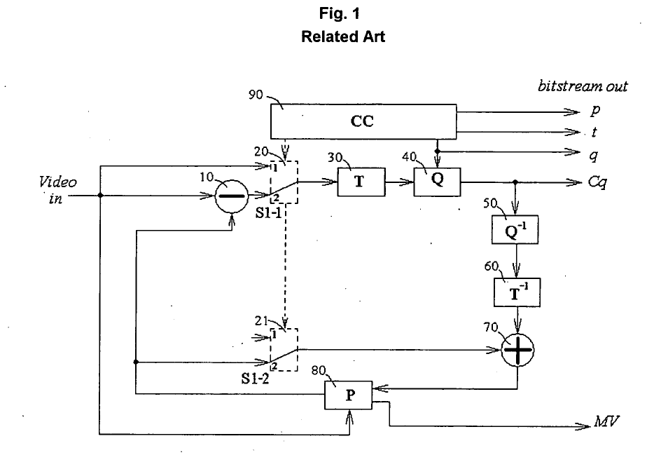

The base of the invented method in comparison with a related art video encoder (see FIG. 1) is usage of the Adaptive Discarder 100 that produces discarding rules for control of the Sections 110, 111 of the Second Two-Section switch unit, and for control of the Single-Section Switch unit 120. The other part of the preferred embodiment of the invented method performs the well-defined functions of video codec and was described above. The input signal for the Adaptive Discarder 100 is the residual Sum of Absolute Difference (SAD) calculated in the Picture Memory With Motion Compensation unit 80 during the inherent motion estimation of macroblocks. In P-mode, both Sections 20 and 21 of the First Two-Section Switch unit are switched in position 2, and output of the Subtractor unit 10 is connected to the input of the Direct Transformer 30. But when scanning all macroblocks of the current frame is carried out, every macroblock is characterized by its residual SAD value. In the Adaptive Discarder 100, the comparison of the residual SAD value with an assigned value of SAD_{T} is performed.

If residual SAD>SAD_{T}, the Adaptive Discarder 100 yields the first controlling signal that turns both Sections 110, 111 of the Second Two-Section Switch unit to position ‘1’. The input signal and the signal from the Picture Memory With Motion Compensation unit 80 are passed to the inputs of the Subtractor 10. The obtained components of the difference macroblock from the output of the Subtractor 10 are passed by Section 20 to the input of the Direct Transformer 30. The obtained coefficients of direct transform from the output of the Direct Transformer 30 are passed to input of the Quantizer 40. If all the quantized coefficients of the current macroblock are equal to zero, the special flag ‘t’ is put into bitstream instead of the set of quantized coefficients. In other case the quantized coefficients are passed into bitstream and at the same time to the input of the Dequantizer 50. Recovered coefficients from the output of the Dequantizer 50 are passed to the input of the Inverse Transformer 60 where the inverse transform is carried out. The signal from the Inverse Transformer 60 comes to the first input of the Adder 70. Here, it is added to the signal from the Picture Memory With Motion Compensation unit 80 that is passed to the second input of the Adder 70 via the Section 21 of the First Two-Section Switch unit. The reconstructed signal from the output of the Adder 70 is passed by the Section 111 of the Second Two-Section Switch unit to the input of the Picture Memory With Motion Compensation unit 80. Here, motion compensation of the new frame is fulfilled and the result is used for its coding. This way is typical for a related art video coding technique.

If residual SAD≦SAD_{T}, the Adaptive Discarder 100 yields another value of the first controlling signal that turns the Sections 110, 111 of the Second Two-Section Switch unit to position ‘2’. No input signal comes in to inputs of the Subtractor 10 and correspondingly, all the consecutive sequence: the Subtractor 10, the Direct Transformer 30, the Quantizer 40, the Dequantizer 50, the Inverse Transformer 60, the Adder 70,—all of them are turned out of processing. The signal from the output of the Picture Memory With Motion Compensation unit 80 is passed by the Section 21 of the First Two-Section Switch unit and by the Section 111 of the Second Two-Section Switch unit directly to the input of the Picture Memory With Motion Compensation unit 80. In the preferred implementation, no transfer is required at all. Therefore, computation load significantly decreases and speed of encoding steeply rises.

Moreover, the Adaptive Discarder 100 yields the second controlling signal.

If residual SAD<SAD_{T} or if residual SAD>SAD_{T}+Δ, where Δ is a small predefined vicinity of the SAD_{T} value, the second controlling signal turns the Single-Section Switch unit 120 to position ‘1’ and input of the Adaptive Discarder 100 is switched out of ‘Cq’ bus.

In other case, if residual SAD is satisfied to the following condition
SAD_{T}<SAD≦SAD_{T}+Δ,
the second controlling signal turns the Single-Section Switch unit 120 to position ‘2’ and the Adaptive Discarder 100 gathers statistics about the number of non-zero quantized coefficients for these macroblocks that have such near to boundary values of SAD.

When all macroblocks of the current k-th frame have been scanned, the mean number of non-zero quantized coefficients, MNC(k), is calculated. The calculated value is used for adaptation of the assigned value of SAD_{T}. For the next (k+1)-th frame, the new value of assigned SAD_{T}(k+1) is calculated as follows:
SAD_{T}(k+1)=SAD_{T}(k)+(MNC(k)−MNC_{T})/L,
where L is a parameter that is proportional to the slope of the curve MNC versus SAD, and MNC_{T} is a fixed value of the mean number of non-zero quantized coefficients that is acceptably to discard for purpose of the forced acceleration of the encoding process.

At that, the MNC_{T} value can be considered as a parameter to regulate a degree of the forced acceleration: the greater MNC_{T} value the more forced acceleration. One can see from results of numerous experiments that discarding 5% of total number of coefficients does not caused noticeable quality degradation, while acceleration of the encoding process is significant.

So, for Wavelet Transform of 16×16 macroblocks, the value MNC_{T}=12 is acceptable.

If the Discrete Cosine Transform (DCT) is used, the macroblock is usually divided into four 8×8 blocks, and DCT is applied to every such block. In this case, the hierarchical procedure of evaluation and discarding yields good results. At first, the whole poor-informative macroblocks are examined and discarded if it is possible, and at second, if a macroblock is to be processed, its blocks are evaluated separately and the poor-informative ones are discarded. So, for DCT of 8×8 blocks, the value MNC_{T} of 1.5 to 3.0 is acceptable.

What is claimed is:

1. A method for acceleration of transform-based block-oriented video encoding, the method comprising besides the main encoding steps of:
a) frame predicting based on motion estimation and motion compensation,
b) subtracting the input and predicted signals,
c) direct block transforming the difference signal,
d) quantizing the coefficients of the transform,
e) dequantizing the quantized coefficients,
f) inverse block transforming of the dequantized coefficients,
g) adding the inverse transformed signal and the predicted signal, and
h) storing the reconstructed signal obtained in the step g) for frame predicting of the next video frame in the step a),
the additional steps for acceleration of the predictive encoding as follows:
i) comparing the residual error of motion estimation with two threshold values: the assigned value T1 and the boundary value T2 that is greater than T1 value by a predefined small supplement,
j) switching out of the all encoding steps from b) to g) for the blocks having the residual error of motion estimation not greater than assigned T1 value and passing the predicted signals from the step a) directly to the step h),
k) switching on the collection of statistics for the blocks having the residual error of motion estimation in the interval between the assigned value T1 and the boundary value T2,
l) adapting the assigned value T1 on the base of collected statistics of macroblock significance criterion,
m) defining the boundary value T2 in accordance with assigned value T1 adapted in step 1).

2. The method according to claim 1, wherein the residual error of motion estimation is calculated as Mean Squared Error (MSE) of the current macroblock and the motion compensated one.

3. The method according to claim 1, wherein the residual error of motion estimation is calculated as Sum of Absolute Difference (SAD) of the current macroblock and the motion compensated one.

4. The method according to claim 1, wherein the macroblock significance criterion is realized as the mean number of non-zero quantized coefficients.

5. The method according to claim 1, wherein the macroblock significance criterion is realized as the mean sum of absolute values of quantized coefficients.

6. The method according to claim 1, wherein the assigned value T1 in the step i) is calculated as a pre-calculated table function of a fixed value of the mean number of non-zero quantized coefficients that is acceptably to discard for purpose of the forced acceleration of the encoding process.

7. The method according to claim 6, wherein the step k) is performed as switching on the calculation of the mean number of non-zero quantized coefficients for all blocks having the residual error of motion estimation in the interval between the assigned value T1 and the boundary value T2.

8. The method according to claim 7, wherein the step 1) is performed as adding a signed additive item having a value that is proportional to the difference of two values: the first value is the mean number of non-zero quantized coefficients fixed in the step i) and the second value is the mean number of non-zero quantized coefficients actually calculated in the step k).

9. The method according to claim 1, wherein the step c) is performed as direct Wavelet Transform and the step f) is performed as inverse Wavelet Transform.

10. The method according to claim 1, wherein the step c) is performed as direct Discrete Cosine Transform and the step f) is performed as inverse Discrete Cosine Transform.

11. The method according to claim 10, wherein the step i) is performed as two hierarchical stages: at first, the whole macroblocks are evaluated, and at second, if a macroblock is to be processed, its blocks are evaluated separately and the poor-informative ones are switched out of all the encoding steps from b) to g).

12. A system for acceleration of transform-based block-oriented video encoder, the system comprising besides the main encoding units of:
a frame predictor based on motion estimation and motion compensation,
a subtractor the input and predicted signals,
a direct block transformer of the difference signal,
a quantizer of the coefficients of the transform,
a dequantizer of the quantized coefficients,
an inverse block transformer of the dequantized coefficients,
an adder of the inverse transformed signal and the predicted signal
a memory for the reconstructed signal obtained in the adder for usage by the frame predictor for the next video frame,
a coding controller, and
a switch for changeover of coding modes,
the additional units for acceleration of the predictive encoding as follows:
a first comparator of the residual error of motion estimation with the assigned threshold value T1,
a second comparator of the residual error of motion estimation with the boundary value T2 that is greater than the assigned threshold value T1 value by a predefined small supplement,
a first switch for disconnection of the encoding units: the subtractor, the direct block transformer, the quantizer, the dequantizer, the inverse block transformer, and the adder, for the blocks having the residual error of motion estimation not greater than assigned T1 value and passing the predicted signals from the frame predictor directly to the memory for the reconstructed signal,
a second switch for engaging the collection of statistics for the blocks having the residual error of motion estimation greater than the assigned value T1 and less than the boundary value T2,
an adaptive discarder for adapting the assigned value T1 and the boundary value T2 on the base of collected statistics.

13. The system according to claim 12, wherein the residual error of motion estimation is calculated as Mean Squared Error (MSE) of the current macroblock and the motion compensated one.

14. The system according to claim 12, wherein the residual error of motion estimation is calculated as Sum of Absolute Difference (SAD) of the current macroblock and the motion compensated one.

15. The system according to claim 12, wherein the assigned value T1 in the first comparator is calculated as a pre-calculated table function of a fixed value of the mean number of non-zero quantized coefficients that is acceptably to discard for purpose of the forced acceleration of the encoding process.

16. The system according to claim 15, wherein the second switch is performed as switching on the calculation of the mean number of non-zero quantized coefficients for all blocks having the residual error of motion estimation in the interval between the assigned value T1 and the boundary value T2.

17. The system according to claim 16, wherein the adaptive discarder is performed as adding a signed additive item having a value that is proportional to the difference of two values: the first value is the mean number of non-zero quantized coefficients actually calculated when the second switch was switched on and the second value is the mean number of non-zero quantized coefficients fixed in the first comparator.

18. The system according to claim 12, wherein the direct block transformer is performed as direct Wavelet Transform and the inverse block transformer is performed as inverse Wavelet Transform.

19. The system according to claim 12, wherein the direct block transformer is performed as direct Discrete Cosine Transform and the inverse block transformer is performed as inverse Discrete Cosine Transform.

20. The system according to claim 19, wherein the first comparator is performed as two successive stages: at first, the whole macroblocks are evaluated, and at second, if a macroblock is to be processed, its blocks are evaluated separately and the poor-informative ones are switched out of all the encoding units: the subtractor, the direct block transformer, the quantizer, the dequantizer, the inverse block transformer, and the adder.
